(19) United States
(12) Patent Application Publication
(10) Pub. No.: US 2026/0079115 A1
(43) Pub. Date: Mar. 19, 2026

(54) LIGHTING DEVICE FOR GENERATING A LINE ILLUMINATION

(71) Applicant: ISRA VISION GmbH, Darmstadt (DE)

(72) Inventors: Julia Barnikol-Oettler, Alsbach-Hähnlein (DE); Oliver Stolz, Gernsheim Rhein (DE)

(21) Appl. No.: 19/327,106

(22) Filed: Sep. 12, 2025

(30) Foreign Application Priority Data
Sep. 18, 2024 (DE) 10 2024 208 944.3

(51) Int. Cl. G01N 21/89; F21V 5/04; F21V 7/00; F21V 13/04

(52) U.S. Cl. CPC G01N 21/8901; F21V 5/04; F21V 7/0091; F21V 13/04; G01N 21/8914

(57) ABSTRACT

A lighting device for generating a line illumination along a longitudinal direction, having a lens element which, along the longitudinal direction, defines an optical center plane and has a constant cross-sectional profile at least over a section, and having one or more light sources arranged along the longitudinal direction on one side of the lens element. The lens element has a transparent lens body with one or more coupling-in surfaces facing the one or more light sources, through which the light emitted by the one or more light sources enters the lens body, with one or more reflection surfaces at which at least a portion of the coupled-in light is totally internally reflected within the lens body, and with one or more coupling-out surfaces through which the coupled-in light exits the lens body. The lens element and the light source or light sources are arranged such that the light exiting the lens body through the coupling-out surfaces converges.

The invention relates to a lighting device for generating a line illumination along a longitudinal direction, having a lens element which defines, along the longitudinal direction, an optical center plane and which, along the longitudinal direction, has a constant cross-sectional profile at least over a section, and having one or more light sources arranged along the longitudinal direction on one side of the lens element. The invention further relates to an apparatus for the optical inspection of an object (“inspection apparatus”) with such a lighting device.

The lighting device and inspection apparatus according to the invention can be used in particular for inspecting transparent webs of material or objects such as glass or structured glass, and also non-transparent webs of material or objects having, for example, a lacquered surface. Possible defects may in particular be surface damage and/or, in the case of transparent material, inclusions such as air bubbles or foreign bodies, or inhomogeneities.

By way of example, reference is made to documents EP 1 742 041 A1 and EP 1 030 173 A1. These disclose apparatuses for surface inspection of moving products. Here, the moving surface to be inspected is captured in image form by at least one camera. Furthermore, a lighting configuration is provided in which individual light sources or a plurality of light sources from a number of light sources arranged one behind the other in the transport direction are selectively activated or deactivated. The resulting individual images are evaluated to detect defects on the surface.

Document DE 198 13 073 A1 is concerned with determining the optical quality of flat glass. For this purpose, a color line camera is provided which views illumination through the glass or in reflection. The focus of the camera is located on the plane of the glass. The illumination arranged transversely to the transport direction illuminates the surface with two different colors in alternation.

A lighting device for generating a line illumination is also known from EP 3 236 198 A1. LEDs arranged in a row are used as light sources, which are switchable independently of one another in at least two groups. An optical element for beam bundling is also assigned to the light sources, which may consist, for example, of a Fresnel lens or a cylindrical lens.

Cylindrical lenses have proven suitable for generating a line illumination. They can be produced relatively inexpensively and in virtually any length as an extruded profile. The imaging properties are sufficiently good to generate, from the light emitted by the LEDs, a convergent beam bundle having a focus at a working distance from approximately 50 mm.

It is an object of the present invention to increase the efficiency of the lighting device for generating a line illumination while keeping the manufacturing costs comparable or lower.

The object is achieved by a lighting device according to claim 1. The lighting device for generating a line illumination along a longitudinal direction has a lens element which, along the longitudinal direction, defines an optical center plane, also referred to as an optical plane, and which, along the longitudinal direction, has a constant cross-sectional profile at least over a section. The lighting device further comprises one or more light sources arranged along the longitudinal direction on one side of the lens element. The lens element has a transparent lens body with one or more coupling-in surfaces facing the one or more light sources, through which the light emitted by the one or more light sources enters the lens body, with one or more reflection surfaces at which at least a portion of the coupled-in light is totally internally reflected within the lens body, and with one or more coupling-out surfaces through which the coupled-in light exits the lens body. The lens element and the light source are arranged such that the light exiting the lens body through the coupling-out surfaces converges.

The coupling-in surfaces, reflection surfaces and coupling-out surfaces are collectively referred to as “optical surfaces” through which the light rays enter or exit the lens body or at which they are reflected. These surfaces are optically functional even when, for example, the light rays pass through these surfaces without refraction. The quality and tolerance requirements on these surfaces are generally higher than on surface sections which have no optical function because they are, for example, aligned parallel to the beam path.

In contrast to a cylindrical lens, total internal reflection takes place inside the lens element according to the invention at the reflection surface. This enables an overall higher light yield, in particular when LEDs are used as light sources, which have a broad emission characteristic. The lens element according to the invention permits lens geometries which, compared with a cylindrical lens and using one and the same LED, result in an increased light yield because the rays that propagate at large emission angles, e.g. angles >60° to the optical plane, are also utilized. In addition, this also allows the use of more efficient LEDs with a broader emission characteristic. Such LEDs, in conjunction with the improved imaging performance of the lens according to the invention, improve the light yield by up to 220% compared with the use of the known LED-cylindrical-lens combination.

At the same time, with the same installation dimensions, the lens element according to the invention has a significantly smaller volume than a cylindrical lens, thereby also reducing the material usage and thus the manufacturing costs.

The principle of internal total reflection is basically known in connection with LED light sources in various applications. For example, so-called TIR lenses are used in spotlights or, in the automotive sector, for headlights and tail lights. The invention is based on the realization that a corresponding geometry can also be transferred to a lens element which, along its longitudinal direction, has a constant cross-sectional profile at least over a section, preferably over the entire optically active length of the lens element and, for manufacturing reasons, particularly preferably over the entire profile length. A challenge here lies in maintaining the required dimensional and surface tolerances over the entire optically active length of the lens element.

Cylindrical lenses have a circular cross-section. This has the advantage that, during cooling after shaping, uniform stresses form in the material that ensure shape stability and thus sufficient optical quality. In general, the geometry of a TIR lens can also be produced in an elongated profile for generating a line illumination by an extrusion process. However, the geometry of TIR lenses necessarily has considerably lower symmetry than a cylinder. As a rule, the optical center plane along the longitudinal direction is the only plane of symmetry of the profile. A corresponding extruded profile therefore tends, in particular when producing very great lengths, to a production-related deformation.

It is therefore preferred that at least one coupling-out surface has at least one step, the step being formed by an offset of the at least one coupling-out surface essentially in the direction of the optical center plane.

By this measure the thickness of the profile and thus the profile cross-sectional area can be deliberately reduced, which can be utilized for more uniform cooling of the profile. In addition, in this way a profile can be realized which is up to 70% lighter than a cylindrical lens with comparable imaging properties.

Strictly speaking, a single step already helps with regard to improved dimensional and shape stability of the profile. With an increasing number of steps, the result in this respect becomes better. However, a larger number of steps is countered by an increase in Fresnel losses. A good compromise has been identified for a coupling-out surface with three steps.

By each step, the coupling-out surface is divided into two adjacent, optically functional partial coupling-out surfaces, which are connected to one another by an offset surface having no optical function. An “offset of the at least one coupling-out surface essentially in the direction of the optical center plane” therefore means that the offset surface lies in a plane which runs parallel to the center plane and is in any case inclined by no more than 15°, preferably no more than 12°, and particularly preferably no more than 10° with respect to the center plane.

The at least one step is particularly preferably formed by an offset of the at least one coupling-out surface parallel to the beam direction of the light rays exiting along the edge of the step.

The edge of the step is located where the plane of the coupling-out surface and the plane of the offset surface intersect. Of course, in practice the edges are not formed arbitrarily sharp, but are typically rounded for manufacturing reasons. A typical rounding radius is between 0.1 and 0.5 mm. Geometric specifications are therefore generally to be understood as including tolerance-related or manufacturing-technically necessary deviations from the ideal geometry described.

The at least one step is preferably dimensioned and arranged such that, for the maximum distance Sₘₐₓ that a reflected light ray travels in the lens body between a reflection surface and a coupling-out surface, and for the minimum distance Sₘᵢₙ that a reflected light ray travels in the lens body between a reflection surface and a coupling-out surface or that a direct light ray travels in the lens body between a coupling-in surface and a coupling-out surface, the following holds: 1<Sₘₐₓ/Sₘᵢₙ<6.

This measure ensures that the thickness of the profile in the direction of the beam path within the lens does not vary more than required by the optical beam path within the lens element, which ensures sufficiently uniform cooling of the profile after shaping and enables the production of long profiles while maintaining the tolerances required for the optical imaging properties.

At least one coupling-out surface preferably has a convexly curved surface through which (predominantly) light rays that are not reflected within the lens body exit the lens body.

This describes the direct light rays which generally enter the lens body near the center plane through a coupling-in surface and exit again on the opposite side without total internal reflection and are focused at the convex coupling-out surface. This describes the (computationally) ideal geometry of the lighting device. In reality, due to manufacturing tolerances and an areal extent of the light source, a small proportion of reflected light rays will also exit the lens body through the convex coupling-out surface, in which sense “predominantly” non-reflected light rays within the lens body are referred to here.

At least one coupling-out surface is inclined toward the center plane, through which (predominantly) light rays reflected within the lens body exit the lens body.

“Inclined toward the center plane” describes the fact that a sharp angle is enclosed outside the lens element between the coupling-out surface and the center plane. In the case of an arrangement of two coupling-out surfaces that is mirror-symmetric with respect to the center plane, the coupling-out surface can thus also be said to be inclined inward. Due to the inwardly inclined coupling-out surfaces, the lens element has a smaller volume, which, similar to the steps, has a positive effect on manufacturing and weight. However, the inclination cannot be selected arbitrarily large because this is at the expense of the imaging properties. Specifically, an inclination that is too large results in higher Fresnel losses.

The reflection surfaces are preferably designed such that the light rays reflected there are, in a first approximation, already focused in such a way that refraction upon exiting through the coupling-out surface is no longer required or desired. The coupling-out surface is therefore preferably inclined with respect to the center axis such that the reflected light rays run essentially perpendicular to the coupling-out surface. If a small proportion of direct light rays exits the lens body through the inclined coupling-out surface, this is tolerable, in which sense “predominantly” light rays reflected within the lens body are referred to here. In practice, it is also not possible for the reflected light rays to run ideally perpendicular to the coupling-out surface. This cannot be achieved, for example, already because the light source is areally extended. In this sense it is sufficient if the reflected light rays run essentially perpendicular to the coupling-out surface within an angular tolerance of ±3°. This is what is meant here by essentially perpendicular.

The at least one step is preferably formed in the at least one coupling-out surface that is inclined toward the center plane.

The combination of the inward inclination of the coupling-out surface with the steps enables a further improvement of the profile with regard to uniform cooling after shaping while at the same time having a small overall size without losses of imaging accuracy.

The lens volume preferably has, in cross-section, a maximum extent Lₘₐₓ and a minimum extent Lₘᵢₙ, wherein the maximum extent Lₘₐₓ denotes the maximum circle diameter that fits completely within the cross-section, and wherein the minimum extent Lₘᵢₙ is the smallest linear distance between a coupling-in surface and a coupling-out surface or between a reflection surface and a coupling-out surface, and wherein the following holds: 1<Lₘₐₓ/Lₘᵢₙ<5.

This configuration too can be achieved by the dimensioning and arrangement of the at least one step and ensures that the thickness of the profile, taking into account the optical imaging properties within the lens, does not vary by more than a factor of 5, which ensures uniform cooling of the profile after shaping and enables the production of profiles up to 6 m long while maintaining the tolerances required for the optical imaging properties.

The cross-sectional profile has a cross-sectional area and a circumferential length, the ratio of cross-sectional area to circumferential length being further preferred to be between 2.0 mm and 4.5 mm, particularly preferably between 2.5 mm and 4.0 mm.

This configuration likewise relates to a further improvement of the cooling of the profile after shaping.

The lens element has an aspect ratio between length and maximum width of at least 10:1, preferably 20:1, particularly preferably 50:1.

The length is the maximum extent of the lens element in the longitudinal direction. The maximum width is the maximum extent of the lens element perpendicular to the center plane.

The lens element has an extrudable profile.

An extrudable profile is a profile whose cross-section perpendicular to the longitudinal direction remains constant. In plastics forming, extrusion processes are used for this. In addition, the profile is designed such that it can be produced within the required tolerance.

The lens element is particularly preferably made of PMMA.

The light source is preferably formed by one or more LEDs. For example, several light sources for generating light of different wavelengths can be formed by, in each case, several identical LEDs arranged next to one another in the longitudinal direction.

The object is further achieved by an apparatus for the optical inspection of an object having a lighting device as described above, wherein the object and the lighting device can be moved relative to one another in a movement direction, wherein the longitudinal direction is arranged transversely to the movement direction and wherein the lighting device can be oriented toward the object in such a way that the light exiting the lens body through the coupling-out surfaces falls on a surface of the object. The apparatus for optical inspection further has an image capture device for capturing images of the illuminated object and a computing unit for evaluating the captured images.

The apparatus for optical inspection is configured for installation, for example, in a transport or production plant, by means of which the object is transported along the movement direction. The apparatus is arranged in a stationary manner on the transport or production plant such that the object is guided past the lens element at a distance which preferably corresponds to the focal length of the lens element. This distance, also referred to as the working distance, is measured from the end face of the lens element on the coupling-out side along the center plane up to the surface of the object.

In reality, the beam bundle of such a TIR lens does not converge on a one-dimensional focal line but forms a waist. The term focal length is therefore understood to mean a focal length range in which the illuminance on the surface of an illuminated object deviates by no more than 25% from the maximum illuminance. In some applications, the apparatus can also be operated such that the object is guided past the lens element at a working distance that lies outside the focal length range, which results in a lower beam concentration on the surface of the object.

Further features and advantages of the invention are explained below with reference to exemplary embodiments in the figures. In the drawings:

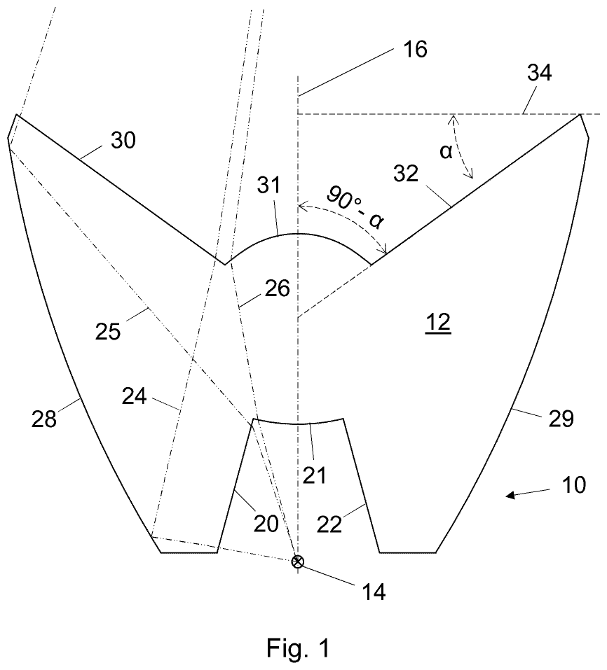

FIG. 1 shows the cross-section through a lens element according to a first embodiment of the invention;

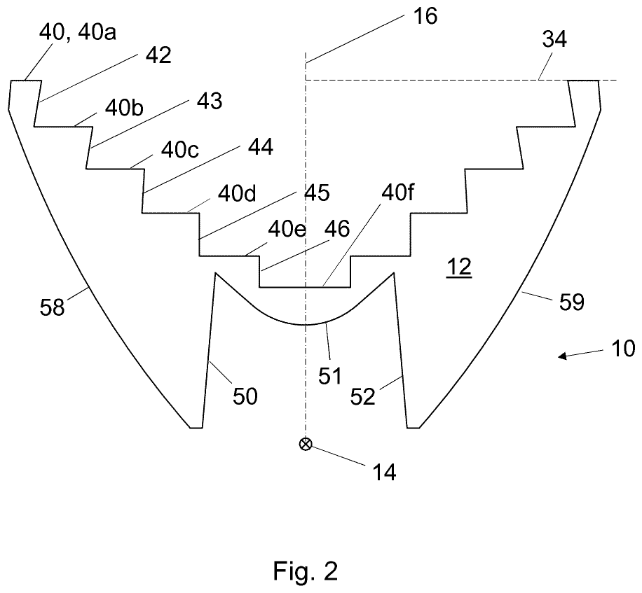

FIG. 2 shows the cross-section through a lens element according to a second embodiment of the invention;

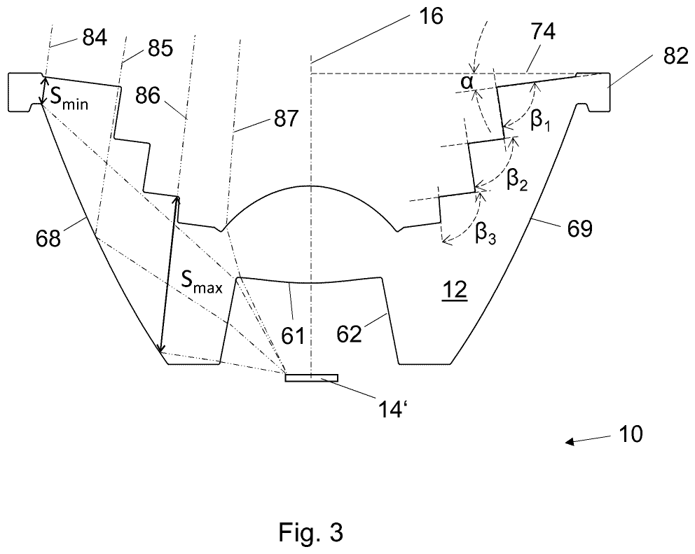

FIG. 3 shows the cross-section through a lens element according to a third embodiment of the invention;

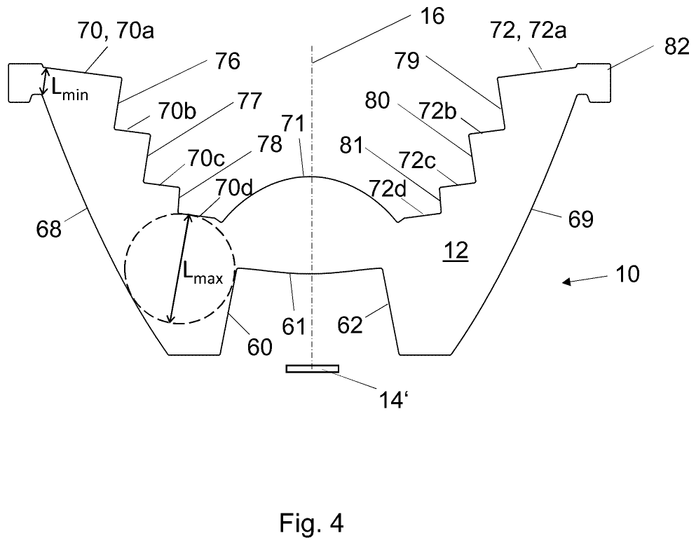

FIG. 4 shows the lens element according to FIG. 3 with different parameterization; and

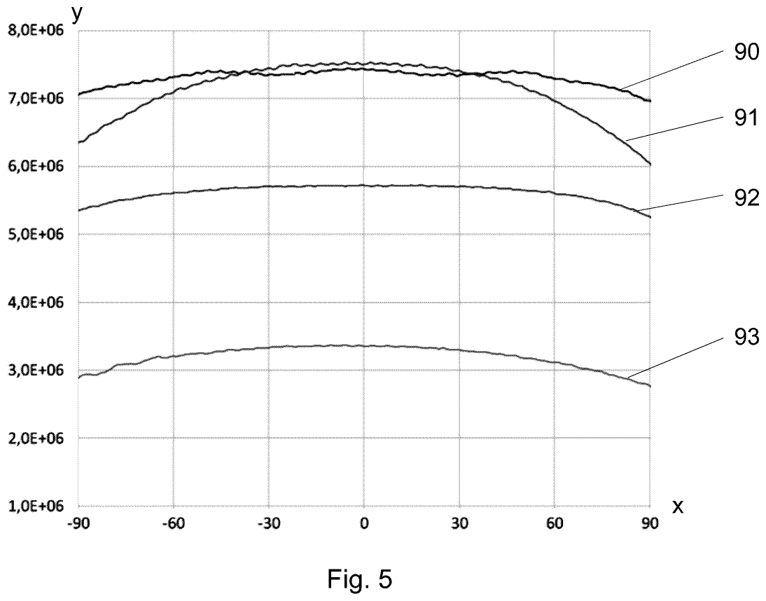

FIG. 5 shows the illuminance using a lighting device according to the invention in comparison with the illuminance using a lighting device with a cylindrical lens.

A first embodiment of the lighting device 10 according to the invention is shown in cross-section transverse to its longitudinal direction in FIG. 1. The lighting device 10 comprises a lens element 12 and a light source 14 arranged along the longitudinal direction on one side of the lens element 12. Along the longitudinal direction, the lens element 12 has, at least over a section and preferably over its entire optically active length, the constant cross-sectional profile shown. The lens element 12 is mirror-symmetric with respect to a center plane 16 extending along the longitudinal direction.

The lens element 12 has a transparent lens body with three coupling-in surfaces 20, 21, 22 facing the light source 14, through which the light emitted by the light source 14 enters the lens body. By way of example, three light rays 24, 25, 26 are shown which run to the left of the center plane 16 in three different directions. The peripheral light rays, represented by light rays 24, 25, enter the lens body through the outer coupling-in surface 20, and the central light rays, represented by light ray 26, enter through the middle coupling-in surface 21. The middle coupling-in surface 21 has a convexly curved surface.

Furthermore, the lens body is delimited peripherally by two reflection surfaces 28, 29 at which at least part of the coupled-in light is totally internally reflected within the lens body. Specifically, these are the peripheral light rays that enter the lens body through the outer coupling-in surfaces 20, 22.

Finally, the lens element 12 has three coupling-out surfaces 30, 31, 32 through which the coupled-in light exits the lens body. The middle coupling-out surface 31 has a convexly curved surface through which predominantly central light rays that are not reflected within the lens body exit the lens body. Depending on the refractive index of the lens material, the convex curvatures of the middle coupling-in surface 20 and the middle coupling-out surface 31 are matched and dimensioned such that the focal length for the central light rays not reflected within the lens body is the same as for the (predominantly) peripheral light rays reflected within the lens body.

The outer coupling-out surfaces 30, 32 are arranged symmetrically on both sides of the center plane and are each inclined toward the center plane. Between the coupling-out surfaces 30, 32 and the center plane 16, a sharp angle (90°−α) is enclosed outside the lens element, where a is the angle of inclination between the respective coupling-out surface and an auxiliary plane 34 parallel to the longitudinal direction and perpendicular to the center plane 16. The end face of the lens element on the coupling-out side, which in the above sense forms the basis for determining the focal length, also lies in the auxiliary plane. Predominantly light rays reflected within the lens body, i.e. peripheral light rays, exit the lens body through the outer coupling-out surfaces 30, 32. Due to the arrangement of the two inwardly inclined outer coupling-out surfaces 30, 31 mirror-symmetric with respect to the center plane 16, the lens element has a cavity below the auxiliary plane and thus a smaller volume compared with a lens element having a flat coupling-out surface lying in the auxiliary plane. However, an inclination that is too steep has the disadvantage that the lens element produces Fresnel losses that are no longer tolerable. Moreover, the overall height of the lens element also increases toward the center plane, which may likewise be undesirable.

As can be seen, the lens element 12 with its coupling-in surfaces 20, 21, 22, reflection surfaces 28, 29 and coupling-out surfaces 30, 31, 32 and the light source 14 are arranged such that the light exiting the lens body through the coupling-out surfaces converges.

A second embodiment of the lighting device 10 according to the invention is shown in cross-section transverse to its longitudinal direction in FIG. 2. It again comprises a lens element 12 and a light source 14 arranged along the longitudinal direction on one side of the lens element 12. Along the longitudinal direction, the cross-sectional profile of the lens element 12 is again constant at least over a section and preferably over its entire optically active length. This lens element 12, too, is mirror-symmetric with respect to a center plane 16 extending along the longitudinal direction.

In contrast to the lens element 12 from FIG. 1, the lens element according to FIG. 2 has only a single flat coupling-out surface 40, in which, in each case, five steps are formed symmetrically on both sides of the center plane 16. The steps are formed by an offset of the coupling-out surface 40 essentially in the direction of the optical center plane 16. By each step, the coupling-out surface 40 is divided into two adjacent, optically functional partial coupling-out surfaces 40a, 40b, 40c, 40d, 40e, 40f, which are connected to one another by offset surfaces 42, 43, 44, 45, 46 having no optical function. More precisely, the offset surfaces 42, 43, 44, 45, 46 lie in planes which are inclined by no more than 10° with respect to the center plane 16, making it possible to incline the offset surfaces such that only a very small, if any, proportion of the light rays exits the lens element through the offset surfaces 42, 43, 44, 45, 46.

A further difference from the lens element 12 of FIG. 1 is the markedly stronger convex curvature of the middle coupling-in surface 51, which is due to the fact that the coupling-out surface 40, including the partial coupling-out surface 40f, extends parallel to the auxiliary plane 34 and therefore contributes less to the refraction of the central light rays.

The remaining geometric shape of the lens element according to FIG. 2, such as, for example, the overall height, the inclination of the outer coupling-in surfaces 20, 22 and the inclination and curvature of the reflection surfaces 28, 29, is adapted to the changed beam path within the lens body so that the light exiting the lens body through the coupling-out surface 40 again converges.

Compared with the lighting device according to FIG. 1, the steps instead of the inclined coupling-out surfaces can reduce the Fresnel losses, and the overall height of the lens element is also reduced. However, the cross-section is severely weakened in some places, which has a negative effect on production quality. Long profiles with this cross-section cannot therefore be reliably produced with sufficient precision.

FIGS. 3 and 4 show the same third embodiment of the lighting device according to the invention. The lens element 12 according to FIGS. 3 and 4 is a combination of the lens elements according to FIGS. 1 and 2. As in the lens element 12 according to FIG. 1, it has three coupling-in surfaces 60, 61, 62 facing the light source 14, of which the middle coupling-in surface 61 has a convexly curved surface. In this figure, the light source 14′ is shown, unlike before, as an extended light source.

As in both other embodiments, the lens body is peripherally delimited by two reflection surfaces 68, 69 at which at least part of the coupled-in light is totally internally reflected within the lens body. Here too, these are the peripheral light rays that enter the lens body through the outer coupling-in surfaces 60, 62.

Finally, the lens element 12 again has three coupling-out surfaces 70, 71, 72. As in the case of the first embodiment, the outer coupling-out surfaces 70, 72 are arranged symmetrically on both sides of the center plane and are each inclined toward the center plane, the angle of inclination a between the outer coupling-out surfaces 70, 72 and the auxiliary plane 74 being smaller compared with that of the first embodiment, which reduces both the Fresnel losses and the overall height compared with the latter. The middle coupling-out surface 71 likewise has, as in the case of the first embodiment, a convexly curved surface through which predominantly central light rays that are not reflected within the lens body exit the lens body. As in the case of FIG. 1, depending on the refractive index of the lens material, the convex curvatures of the middle coupling-in surface 20 and the middle coupling-out surface 71 are matched and dimensioned such that the focal length for the central light rays not reflected within the lens body is the same as for the (predominantly) peripheral light rays reflected within the lens body.

At the same time, as in the second embodiment, the outer coupling-out surfaces 70, 72 are provided with a plurality of steps. In this case, three steps are arranged in each case symmetrically on both sides of the center plane 16. The steps are formed by an offset of the outer coupling-out surfaces 70, 72. By each step, the coupling-out surfaces 70, 72 are divided in each case into two adjacent, optically functional partial coupling-out surfaces 70a, 70b, 70c, 70d and 72a, 72b, 72c, 72d, respectively, which extend parallel at the same inclination angle α to the auxiliary plane 74 or the end face on the coupling-out side and which are connected to one another by the offset surfaces 76, 77, 78 and 79, 80, 81, respectively; see FIG. 4. Where the planes of the partial coupling-out surfaces and the planes of the offset surfaces intersect, an edge is formed in each case.

In each case laterally outside the reflection surfaces 68, 69 and the outer coupling-out surfaces 70, 72 there is integrally formed a holding rim 82 for mounting the lens element in a housing (not shown) of the lighting device.

In FIG. 3, by way of example, four light rays 84, 85, 86, 87 are shown which run to the left of the center plane 16 in four different directions. The peripheral light rays, represented by light rays 84, 85, 86, enter the lens body through the outer coupling-in surface 60, and the central light rays, represented by light ray 87, enter through the middle coupling-in surface 61. As can be seen, for example, from light rays 85 and 86, the offset surfaces 76, 77 and 78 run parallel to the beam direction of the light rays that exit along the respective edge of that step. The offset surfaces therefore have no optical function. Since the light rays converge, the offset surfaces are also not parallel to one another, but, viewed from the outside to the inside, enclose increasing intermediate angles β1 to β3 between the partial coupling-out surfaces and the respective offset surfaces.

The embodiment of the lighting device according to FIGS. 3 and 4 combines the advantages of both embodiments according to FIGS. 1 and 2. Both the Fresnel losses are reduced due to the steps and the less strongly inclined coupling-out surfaces, and at the same time the overall height of the lens element is reduced. At the same time, by combining the inclination of the outer coupling-out surfaces with the steps, it has been possible to provide a profile which has a cross-section with fewer weak points and therefore enables the production of long profiles while maintaining the tolerances required for the optical imaging properties.

In particular, as illustrated in FIG. 3 by light rays 84 and 86, the steps are dimensioned and arranged such that a maximum distance Sₘₐₓ which reflected light ray 86 travels in the lens body between the reflection surface 68 and the partial coupling-out surface 70c, and a minimum distance Sₘᵢₙ which reflected light ray 84 travels in the lens body between the reflection surface 68 and the partial coupling-out surface 70a, have a ratio Sₘₐₓ/Sₘᵢₙ of approximately 5.5.

In addition, as can be seen in FIG. 4, the lens volume has, in cross-section, a maximum extent Lₘₐₓ and a minimum extent Lₘᵢₙ, wherein the maximum extent Lₘₐₓ denotes the maximum circle diameter that fits completely within the cross-section, and wherein the minimum extent Lₘᵢₙ is the smallest linear distance between the reflection surface 68 and the partial coupling-out surface 70a, between which a ratio Lₘₐₓ/Lₘᵢₙ of 3.7 is maintained.

This measure ensures that the thickness of the profile in the direction of the beam path within the lens does not vary more than required by the optical beam path within the lens element, which ensures sufficiently uniform cooling of the profile after shaping and enables the production of long profiles while maintaining the tolerances required for the optical imaging properties.

Finally, in this embodiment the cross-sectional profile, with dimensions of 60 mm in width and 30 mm in height, has a cross-sectional area of 710 mm² and a circumferential length of 215 mm, resulting in a ratio of cross-sectional area to circumferential length of 3.3 mm.

Each of these three features—and in particular all three features in combination—ensure that the profile cools uniformly after shaping and can therefore be produced in lengths of 6 m while maintaining the tolerances required for the optical imaging properties.

FIG. 5 shows a diagram which, along the center plane, plots the illuminance using a lighting device according to the invention with a TIR lens according to FIGS. 3 and 4 in comparison with the illuminance using a lighting device with a cylindrical lens in each case at two different working distances. The lighting devices each had a length of 300 mm. On the horizontal x-axis, the distance in the longitudinal direction from the center of the lighting device to both sides is plotted in mm. On the y-axis, the illuminance on the surface of the illuminated object is plotted in Ix.

Curve 90 represents the illuminance of the lighting device according to the invention along the center plane on the surface of an object at a distance of 50 mm. Curve 91 represents the illuminance of the lighting device according to the invention along the center plane on the surface of an object at a distance of 150 mm. Curve 92 represents the illuminance of the lighting device with a cylindrical lens along the center plane on the surface of an object at a distance of 50 mm. Curve 93 represents the illuminance of the lighting device with a cylindrical lens along the center plane on the surface of an object at a distance of 150 mm.

With the lighting device having a TIR lens element according to the invention, a significantly higher absolute illuminance can be achieved than with the cylindrical lenses, as shown by the diagram. For the working distance of 150 mm, this is more than 120% higher when using the TIR lens element and, for the working distance of 50 mm, still just under 30% higher than with the cylindrical lens element. Associated with this, the lighting device according to the invention with a TIR lens element exhibits a significantly lower dependence of illuminance on the working distance. The variation in illuminance over the entire working-distance range from 50 mm to 150 mm is less than 25%.

Since the lighting devices in each case extend along the longitudinal direction only 60 mm beyond the diagrams shown, a slight drop in intensities toward the edges at a small working distance and a pronounced drop in intensities at a large working distance can be seen, irrespective of the respective lighting device and the respective working distance. This effect occurs fundamentally only at the edges and is negligible in practice because the lighting devices used have dimensions of several meters in the longitudinal direction.

### LIST OF REFERENCE SIGNS

10 lighting device
12 lens element
14, 14′ light source
16 center plane
20 outer coupling-in surface
21 middle coupling-in surface
22 outer coupling-in surface
24 light ray
25 light ray
26 light ray
28 reflection surfaces
29 reflection surfaces
30 outer coupling-out surface
31 middle coupling-out surface
32 outer coupling-out surface
34 auxiliary plane
40 coupling-out surface
40a partial coupling-out surface
40b partial coupling-out surface
40 partial coupling-out surface
40d partial coupling-out surface
40e partial coupling-out surface
40f partial coupling-out surface
42 offset surface
43 offset surface
44 offset surface
45 offset surface
46 offset surface
50 outer coupling-in surface
51 middle coupling-in surface
52 outer coupling-in surface
54 light ray
55 light ray
56 light ray
58 reflection surfaces
59 reflection surfaces
60 outer coupling-in surface
61 middle coupling-in surface
62 outer coupling-in surface
68 reflection surfaces
69 reflection surfaces
70 outer coupling-out surface
70a outer partial coupling-out surface
70b outer partial coupling-out surface
70c outer partial coupling-out surface
70d outer partial coupling-out surface
71 middle coupling-out surface
72 outer coupling-out surface
72a outer partial coupling-out surface
72b outer partial coupling-out surface
72c outer partial coupling-out surface
72d outer partial coupling-out surface
74 auxiliary plane
76 offset surface
77 offset surface
78 offset surface
79 offset surface
80 offset surface
81 offset surface
82 holding rim
84 light ray
85 light ray
86 light ray
87 light ray
90 illuminance profile of a lens element according to the invention
91 illuminance profile of a lens element according to the invention
92 illuminance profile of a cylindrical-lens element
93 illuminance profile of a cylindrical-lens element
α angle of inclination of the outer coupling-out surfaces

1. A lighting device for generating a line illumination along a longitudinal direction, comprising:
a lens element which, along the longitudinal direction, defines an optical center plane and which, along the longitudinal direction, has a constant cross-sectional profile at least over a section; and
one or more light sources arranged along the longitudinal direction on one side of the lens element,
wherein the lens element has a transparent lens body with one or more coupling-in surfaces facing the one or more light sources, through which the light emitted by the one or more light sources enters the lens body, with one or more reflection surfaces at which at least part of the coupled-in light is totally internally reflected within the lens body, and with one or more coupling-out surfaces through which the coupled-in light exits the lens body, and
wherein the lens element and the light source or the light sources are arranged such that the light exiting the lens body through the coupling-out surfaces converges.

2. The lighting device according to claim 1, wherein at least one of the one or more coupling-out surfaces has at least one step, the step being formed by an offset of the at least one coupling-out surface essentially in the direction of the optical center plane.

3. The lighting device according to claim 2, wherein the at least one step is formed by an offset of the at least one coupling-out surface parallel to the beam direction of the light rays exiting along the edge of the step.

4. The lighting device according to claim 2, wherein the at least one step is dimensioned and arranged such that, for the maximum distance Sₘₐₓ that a reflected light ray travels between a reflection surface of the one or more reflection surfaces and the at least one coupling-out surface in the lens body, and for the minimum distance Sₘᵢₙ that a reflected light ray travels between the reflection surface and the at least one coupling-out surface in the lens body or that a direct light ray travels between at least one of the one or more coupling-in surfaces and the at least one coupling-out surface in the lens body, the following holds:
$$1 < {S}_{max} / {S}_{min} < 6 .$$

5. The lighting device according to claim 1, wherein at least one of the one or more coupling-out surfaces has a convexly curved surface through which light rays that are not reflected within the lens body exit the lens body.

6. The lighting device according to claim 1, wherein at least one of the one or more coupling-out surfaces is inclined toward the center plane, through which light rays reflected within the lens body exit the lens body.

7. The lighting device according to claim 6, wherein at least one of the one or more coupling-out surfaces has at least one step, the step being formed by an offset of the at least one coupling-out surface essentially in the direction of the optical center plane, and wherein the at least one step is formed in the at least one coupling-out surface that is inclined toward the center plane.

8. The lighting device according to claim 1, wherein the lens volume has, in cross-section, a maximum extent Lₘₐₓ and a minimum extent Lₘᵢₙ, wherein the maximum extent Lₘₐₓ denotes the maximum circle diameter that fits completely within the cross-section, and wherein the minimum extent Lₘᵢₙ is the smallest linear distance between at least one of the one or more coupling-in surfaces and at least one of the one or more coupling-out surfaces or between at least one of the one or more reflection surfaces and the at least one coupling-out surface, and wherein the following holds:
$$1 < {L}_{max} / {L}_{min} < 5.$$

9. The lighting device according to claim 1, wherein the cross-sectional profile has a cross-sectional area and a circumferential length, the ratio of cross-sectional area to circumferential length being between 2.0 mm and 4.5 mm.

10. The lighting device according to claim 1, wherein the lens element has an aspect ratio between length and maximum width of at least 10:1.

11. The lighting device according to claim 1, wherein the lens element has an extrudable profile.

12. The lighting device according to claim 1, wherein the lens element is made of PMMA.

13. The lighting device according to claim 1, wherein the light source is formed by one or more LEDs.

14. The lighting device according to claim 2, wherein the at least one coupling-out surface, has three steps.

15. An apparatus for the optical inspection of an object, comprising:
the lighting device according to claim 1, wherein the object and the lighting device can be moved relative to one another in a movement direction, wherein the longitudinal direction is arranged transversely to the movement direction and wherein the lighting device can be oriented toward the object in such a way that the light exiting the lens body through the one or more coupling-out surfaces falls on a surface of the object;
an image capture device for capturing images of the illuminated object; and
a computing unit for evaluating the captured images.
